(19) United States
(12) Patent Application Publication
(10) Pub. No.: US 2004/0011731 A1
(43) Pub. Date: Jan. 22, 2004

(54) Storm drain filter system

(76) Inventor: Peter S. Sanguinetti, Lodi, CA (US)

Correspondence Address: STOUT, UXA, BUYAN & MULLINS LLP, 4 VENTURE, SUITE 300, IRVINE, CA, 92618, US

(21) Appl. No.: 10/242,867

(22) Filed: Sep. 13, 2002

Related U.S. Application Data
(63) Continuation-in-part of application No. 09/810,301, filed on Mar. 16, 2001, now Pat. No. 6,537,446.

(51) Int. Cl. B01D 24/02

(52) U.S. Cl. 210/483

(57) ABSTRACT

Apparatus for removing debris from water passing through a storm drain having an inlet is provided. The apparatus generally includes a flexible mesh debris trap sized to fit within the storm drain and substantially overlap a peripheral edge of the inlet, and structured to separate debris from a water flow passing therethrough. The apparatus further includes a frame assembly connectable to the debris trap and structured to bear on a surface of the storm drain so as to be effective to secure the debris trap in place therein independently of any storm drain grate being placed on the inlet.

The present invention generally relates to a storm drain filter system and more specifically relates to a temporary storm drain filter system for filtering water flowing into a storm drain within or adjacent a construction site or similar location.

Drainage systems collect and direct rainwater and runoff to underground storm sewers to prevent flooding of streets. In some geographic regions, this untreated water is drained directly into the ocean not far from public beaches. Until relatively recently, it was not well appreciated that even residential runoff water can be highly contaminated, and may pose serious threats to the environment and public health.

Typical storm drainage systems include drain inlets placed at margins of streets and roadways and adjacent sidewalks. The drain inlet is commonly equipped with a removable iron grate element that covers at least a portion of the inlet. In addition to providing a safety means, for example to prevent small children and animals from falling into the drain opening, the grate element is designed to prevent some of the relatively larger debris and trash items, such as tree branches, large paper or plastic containers, from entering the storm drain inlet. However, substantial volumes of relatively smaller trash items and debris, including lawn clippings, leaves, empty beverage containers, paper and plastic wrappers and the like, regularly pass into storm drains despite the use of iron grates. These items will eventually cause clogging of the drainage system if not periodically removed. In addition, such iron grates have been found to be ineffective in preventing gradual accumulation of solid materials that enter the drain inlet through open spaces between edges of the drain inlet and a perimeter of the grate element.

Assemblies have been developed for filtering a water flow entering drain system inlets. For example, it is known to place a screen or other porous element below the grate element to collect smaller trash and debris. However, such systems are prone to becoming clogged with debris, thereby obstructing water flow into the storm drain. In addition, such assemblies have not been designed for screening relatively low water flows into the drain inlet. A particularly slow water flow will often bypass the assembly entirely by seeping through unfiltered areas between edges of the assembly and the drain inlet.

Moreover, such periods of low water flow, especially following a relatively long “dry spell” tend to bring highly contaminated runoff water into the drains. This is due to long term accumulation of oils, automobile fluids, dust, dirt, lawn pesticides and other contaminants in the gutter areas of residential and industrial streets.

Devices have been proposed to address the problem of polluted runoff water in drainage systems. For example, U.S. Pat. No. 6,106,707 to Morris et al., which is incorporated herein in its entirety by this specific reference, discloses a modular insert for curb-inlet storm drains for collecting both trash and oil and other hydrocarbons. The device generally comprises a perforated hopper that fits inside a storm drain inlet. The hopper contains fragments of oil absorbent material for entrapping oil in runoff water flowing through the hopper. Although addressing some of the problems associated with present drainage systems, the Morris et al. device and similar conventional devices may be inconvenient and expensive to maintain and do not address other problems that are solved by the present invention.

A useful drainage filter system has been developed and is disclosed in U.S. patent application No. 09/810,301, filed Mar. 16, 2001, having common inventorship herewith, and incorporated in it entirety herein by this specific reference. This system includes a genrally rectangular shaped metal frame which substantially overlaps a peripheral edge of a storm drain inlet. The system includes a porous element connected to the frame for filtering a flow of water passing through the storm drain inlet.

The present invention is particularly directed to addressing problems associated with runoff water within or adjacent a construction site. Such runoff water is particularly problematic in that it naturally contains a substantial amount of suspended silt, particulate matter, pulverized stone and other debris. This poses particularly difficult problems for management of drainage systems which must comply with strict regulations concerning allowable levels of sediment in runoff water entering a municipal drainage system. Sandbags and other barriers placed adjacent the drains only temporarily obstruct larger materials from entering the drain, while mud, silt and sediment flow around such barriers and into drain inlets. Conventional filters for use at such construction site storm drains quickly gather large amounts of debris that must be removed to prevent obstruction of the drain inlet.

DiLoreto, Jr. et al, U.S. Pat. No. 6,149,803 issued Nov. 21, 2000 and incorporated in its entirety herein by this specific reference, discloses a storm sewer catch basin filter. The filter is attached to a storm drain by means of radially extending arms having ends that are held in place by means of a storm drain grate. The present invention provides a highly effective, inexpensive storm drain filter system for use particularly within or adjacent a construction site.

### SUMMARY OF THE INVENTION

New apparatus for removing debris from runoff water entering a storm drain have been discovered. The apparatus are straightforward to assemble, easy to use, inexpensive to manufacture and highly effective in filtering a flow of water containing a substantial amount of silt, particulate material and/or other debris. Moreover, the apparatus are conveniently collapsible, relatively lightweight and portable.

In accordance with the present invention, apparatus for removing debris from water passing through a storm drain having an inlet is provided. The apparatus generally comprises a debris trap sized to fit within the storm drain, and structured to separate debris from a water flow passing therethrough. For example, the debris trap comprises a flexible porous element, preferably made of a material having a flow rate capacity of at least about 145 gallons per minute per square foot, and a 40 Sieve (U.S.) porosity. In addition, the apparatus in accordance with the invention comprises a frame assembly connectable to the debris trap and structured to bear on a surface of the storm drain so as to be effective to secure the debris trap in place therein.

Preferably, the frame assembly is effective to secure the debris trap in place, suspended within the storm drain opening, independently of any storm drain grate being placed on the inlet. Specifically, the frame assembly is structured to be capable of supporting the weight of the debris trap and debris therein by engagement between the frame assembly and a ledge projecting from the interior wall of the storm drain.

Advantageously, the frame assembly is structured to engage an inner wall of the storm drain in such a way that the entire assembly is supported thereby. Unlike prior art filter devices which rely upon the heavy grate of the storm drain as a means to secure and support the filter, the present invention is structured to be fully supportable by the engagement between the frame of the apparatus and the ledge projecting from the wall of the storm drain and is effective in holding and supporting the debris trap and a substantial volume of debris therein without any other form of support.

In another advantageous aspect of the present invention, the frame assembly preferably comprises a first frame portion having an adjustable length and a second frame portion having a fixed length. More specifically, the first frame portion may comprise two adjustable length rods which are sized to fit within the storm drain along a length thereof. The second frame portion includes two rods each having a fixed length about equal to a width of a typical storm drain. The fixed length of the second frame portion is no longer than a width of the storm drain. When assembled, the frame is located within, and generally aligning a periphery of the storm drain inlet.

The apparatus of the present invention may include a pocket defined within the debris trap and structured for receiving the second frame portion.

Once the apparatus is placed within the storm drain, with the second frame portions resting upon an inner ledge projecting from the wall of the drain, the apparatus can fully support the weight of the apparatus at full capacity, for example up to about 220 pounds of debris. Absence or removal of the iron grate of the storm drain does not weaken or otherwise effect the stability of the apparatus once the apparatus has been installed and filled with debris. Unlike prior art storm drain filters, the apparatus will not fall, collapse or become unstable upon removal of the iron grate.

In addition, the entire apparatus is easily assembled and disassembled and can be stored using a minimal amount of space. In one embodiment of the invention, the frame assembly is collapsible and the debris trap is flexible such that the entire apparatus can be easily carried by a single person.

### BRIEF DESCRIPTION OF THE DRAWINGS

The present invention will be more clearly understood and the objects and advantages thereof better appreciated with reference to the following Detailed Description, when considered in conjunction with the following Drawings of which:

FIG. 1 shows a top plan view of the apparatus of the invention prior to installation thereof in a storm drain.

FIG. 2 shows a perspective view of the apparatus of FIG. 1, as installed in a storm drain.

FIG. 3 shows a cross-sectional view of the apparatus of FIG. 1 within the storm drain.

FIG. 4 shows a perspective view of the apparatus of FIG. 1 as installed in a storm drain with a removable grate.

FIG. 5 shows a top plan view of another embodiment of the invention.

FIG. 6 shows a storm drain having a circular inlet and a removable grate.

FIG. 7 shows a perspective view of the embodiment shown in FIG. 5 as installed to the storm drain shown in FIG. 6.

FIG. 8 shows the same view as FIG. 7 with the grate placed over the circular inlet.

### DETAILED DESCRIPTION OF THE INVENTION

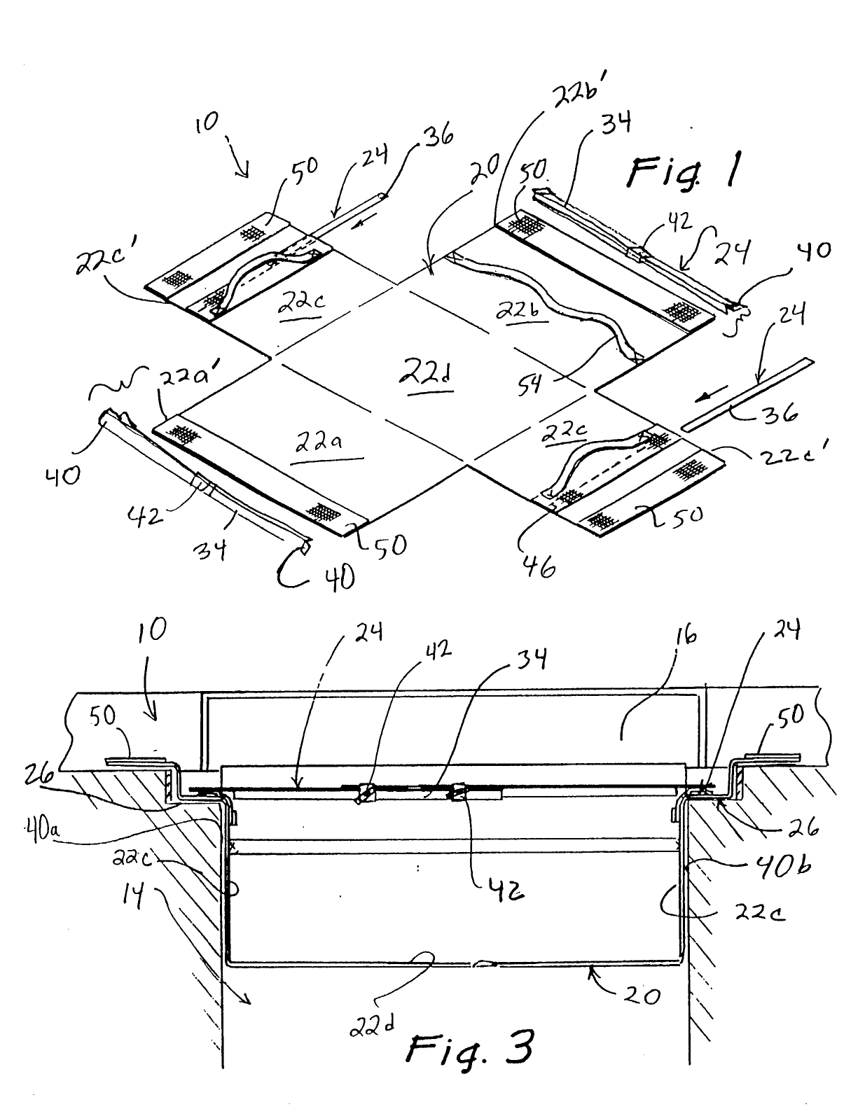

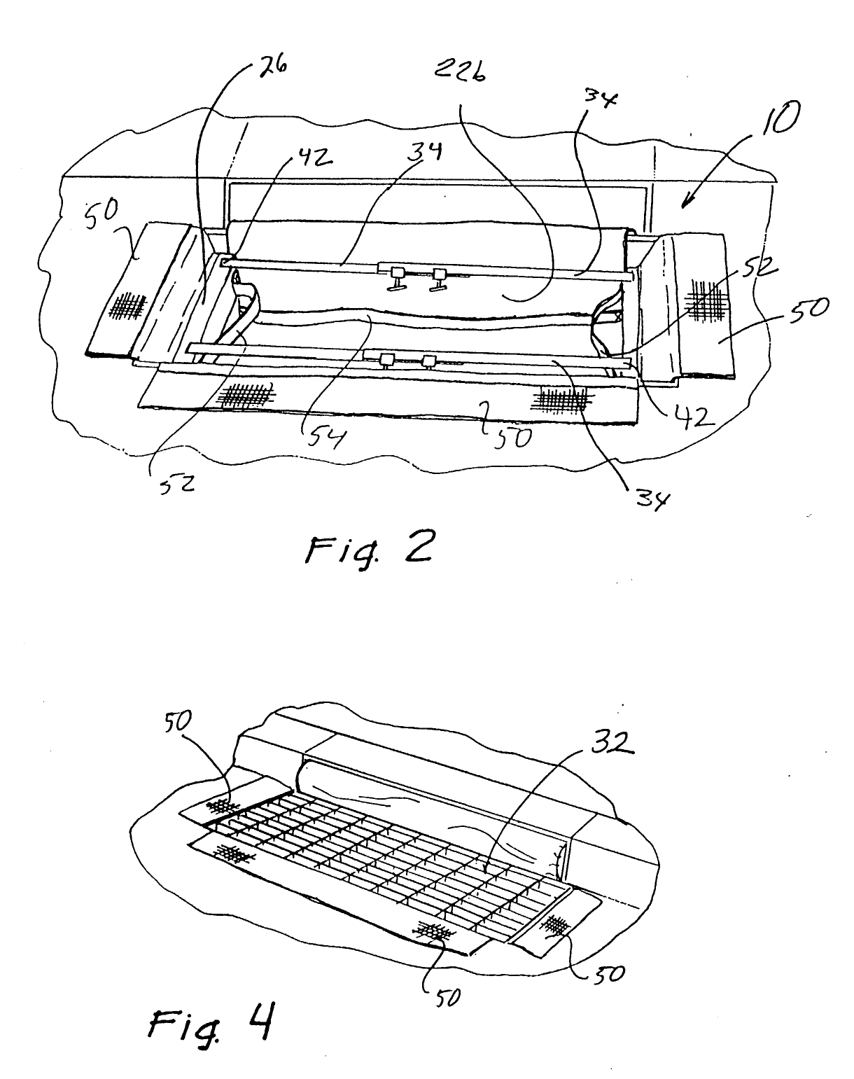

Turning now to FIG. 1, a temporary debris trap apparatus in accordance with the present invention is shown generally at 10. Turning now as well to FIGS. 2 and 3, the apparatus 10 is designed to be installed, for example temporarily installed, within a storm drain 14 having an inlet 16, for example a curbside storm drain 14 having a rectangular inlet 16. The apparatus 10 is particularly useful for filtering a flow, for example runoff, passing into the drain 14. The apparatus 10 is effective in trapping and removing silt, sediment, and other particulate matter which often makes up a relatively large proportion of runoff water from open, bare soil surface areas, such as newly developed areas or areas under construction or development.

The apparatus 10 generally comprises a debris trap 20 sized to fit within the storm drain 14 and structured to separate debris from a flow of water passing therethrough. The debris trap 20 may comprise, for example, a flexible mesh material, for example a nylon mesh material having a suitable flow rate capacity for the desired application. Preferably, the flow rate capacity of the debris trap material is at least about 145 gallons per minute per square foot. For example, the debris trap material may have a 40 Sieve (U.S.) porosity. This porosity allows the debris trap to capture fine particulate material present in runoff water, for example rain water that has not been absorbed into the earth at a construction site, while allowing a substantially steady and consistent draining of the flow into the storm drain 14.

The debris trap 20 is preferably structured to lie substantially flat when in an unassembled configuration, such as shown in FIG. 1. As shown, the debris trap 20 generally includes a front panel 22a, a rear panel 22b, and first and second side panels 22c. Each of the panels 22a, 22b and 22c include an edge or seam common to a substantially rectangular floor panel 22d. The panels 22a, 22b, 22c, and 22d may all be cut from a single piece of material. Alternatively, the panels 22a, 22b, 22c, and 22d sewn or otherwise secured together at common seams.

Referring specifically to FIG. 3, the apparatus 10 further includes a frame assembly 24 connectable to the debris trap 20 and structured to support the debris trap 20 in a substantially suspended position within the storm drain 14. More particularly, the frame assembly 24 is structured to bear against, or rest upon an inner surface, for example a projection or ledge 26, of the storm drain 14.

For example, FIG. 3 shows a cross sectional view of a typical storm drain 14 which includes a peripheral projection or ledge 26 upon which a removable iron grate 32 (see FIG. 4) is typically set.

Importantly, the apparatus 10 of the present invention is structured to capable of being suspended by means of the frame assembly 24, within the storm drain 14 without any other form of support, for example without the storm drain grate 32 securing the apparatus 10. In other words, the apparatus is structured to be capable of being held in place using only the components of the apparatus itself and without bolts, clamps or other mechanisms connecting the frame assembly to the storm drain. Unlike conventional drainage devices, there is no need for the apparatus 10 to be held in position by means of the grate 32 or any other object being used as a means of bolting, clamping, pinching or otherwise securing the apparatus 10 to the storm drain 14.

Advantageously, the apparatus 10 is structured to effectively hold and support up to about 220 pounds of debris or greater, even during high velocity flow conditions.

Turning back to FIG. 1, the frame assembly 24 preferably comprises a plurality of separable elements made of steel or other suitable material. For example, the frame assembly 24 comprises at least one first frame portion 34 sized and structured to extend across a length of the storm drain, and a least one second frame portion 36 sized and structured for extending across a width of the storm drain. More specifically, in the embodiment of the invention shown in FIGS. 1-4, the frame assembly 24 includes two first frame portions 34 and two second frame portions 36.

Preferably, the first frame portion 34 has an adjustable length. Turning to FIG. 3, the first frame portion 34 is structured to be extendable across a length of the storm drain inlet 16, to span a distance defined between a first side surface 40a of the drain to an opposite side surface 40b of the drain. The first frame portion 34 preferably includes flat end portions 40 structured to bear against the ledge 26. The length of the first frame portion preferably is adjustable to substantially correspond to a length of the storm drain inlet 16. This may be accomplished in any number of ways. In the embodiment shown, each first frame portion 34 comprises two slidably engageable connected bars 34a and 34b, and a mechanism 42 for substantially locking each of the bars 34a and 34b at a desired, fixed position with respect to the other of the bars 34a and 34b to define a desired length.

Turning back now to FIG. 1, the second frame portion 36 may comprise a substantially flat bar having a width of about 2 inches and a fixed length, about equal to, and no longer than, a width of the storm drain inlet 16.

Referring now also to FIG. 3, the debris trap 20 preferably includes a tube or pocket 46 defined in each of the two side panels 22c and structured for slidably receiving the second frame portion 36.

Installation of the apparatus 10 may be performed as follows. The storm drain grate 32 is removed from the storm drain inlet 16. The storm drain grate 32 is measured and the measurements thereof noted. These measurements are used to determine the appropriate size of the apparatus 10 required. The debris trap 20 is supplied to the user in a folded, compact configuration, with each of the first and second frame portions 34, 36 lying substantially parallel to one another, and the flexible debris trap 20 enveloping the frame assembly 24. The debris trap 20 is then unfurled into the flat configuration shown in FIG. 1. Each of the second frame portions 36 is inserted into the pockets 46 defined in side panels 22c. The apparatus 10 is pushed into the storm drain inlet 16 and fitted therein such that the bottom panel 22d is generally horizontally disposed, and the side panels 22c extend outwardly from the drain inlet 16 to substantially cover the ledge 26. The second frame portions 36 (enclosed within the panels 22c) are set upon and bear against the ledge 26 as shown in FIG. 3. Next, the first frame portions 34 are adjusted in size, if necessary, to fit within the storm drain inlet 16. Specifically, the first frame portions 34 are sized to extend from one inner ledge 26 to the other, opposite inner ledge 26. The first frame portions 34 are each placed within the inlet 16 with flat end portions 42 bearing substantially against the panel-covered ledge 26. The assembled, installed apparatus 10 is most clearly shown in FIG. 2.

Although not necessary for holding the apparatus in place, the storm drain grate 32 is then typically replaced to cover the inlet 16 as shown in FIG. 4.

In another aspect of the invention, the apparatus 10 is preferably structured to substantially prevent bypass of the debris trap 20, particularly during low water flow conditions. For example, referring now to FIGS. 2 and 3, a peripheral portion 22a′, 22b′ and 22c′ of each of the panels 22a, 22b and 22c, respectively, are sized and shaped to substantially overlap a peripheral edge of the inlet 16 of the storm drain 14. In addition, each panel 22a, 22b and 22c may include an element 50 made of heavy gauge material, which functions in part to provide additional weight to the peripheral portion 22a′, 22b′ and 22c′ of each panel 22a, 22b and 22c. This structure substantially prevents low flowing water from seeping beneath the panels 22a, 22b and 22c and bypassing the debris trap 20.

Other advantageous features of the invention are shown in FIGS. 1 and 2. Flexible handles 52, for example comprising brightly colored nylon straps, secured for example to side panels 22c, are preferably provided for enabling the apparatus 10 to be manually removed from the drain inlet 16. For example, in order to remove the debris trap 20, for example for periodic maintenance and/or cleaning, the adjustable first frame portions 34 are loosened and removed. The handles 52 are grasped and pulled upwardly, the debris trap 20 from the drain 14. Debris within the debris trap 20 can be dumped at a suitable location, and the debris trap rinsed and reused.

In addition, an indicator element 54 may be provided as a means for indicating when the apparatus 10 requires emptying or cleaning. The indicator element 54 may comprise a visually noticeable line, for example comprised of a brightly colored nylon strap material, secured to the debris trap 20 at a position within the apparatus at a suitable location beneath ground level. When the indicator element 54 is no longer visible, or is noticeably faded in appearance, the apparatus 10 should be removed and cleaned. Preferably, the indicator element 54 is provided on back panel 22b, where it will be most visible.

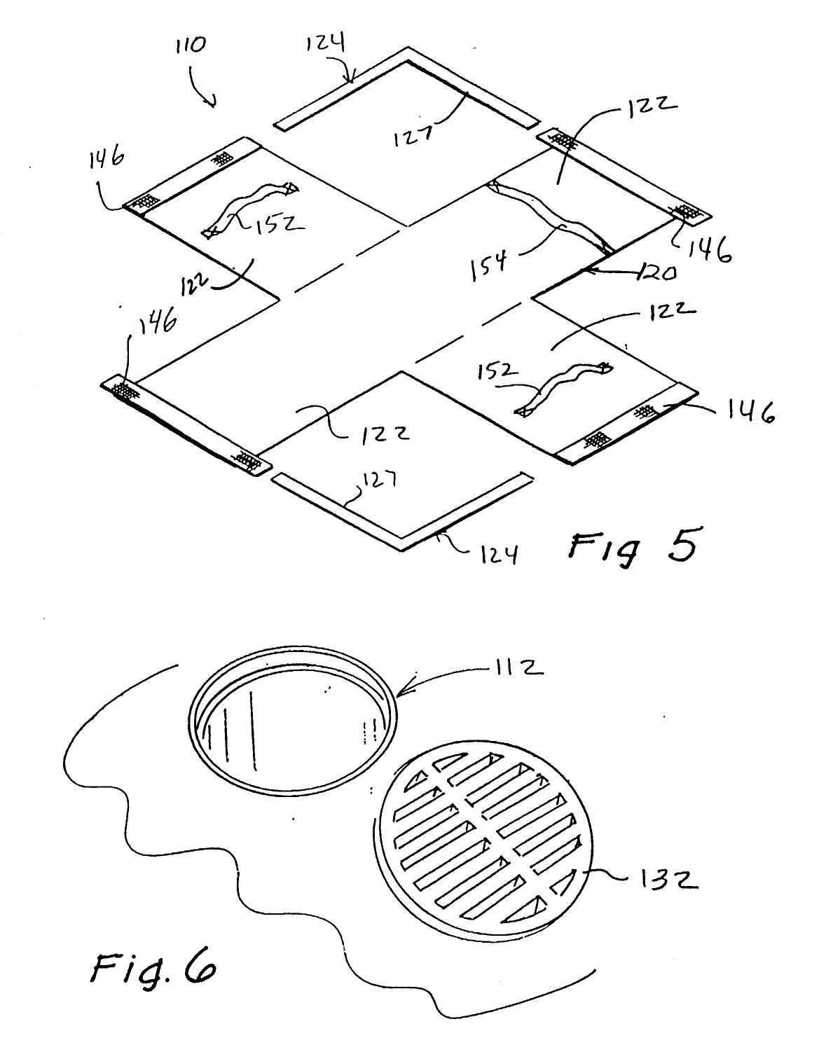

Turning now to FIGS. 5-8, another embodiment of the invention is shown generally at 110, with like elements given like reference numerals increased by 100.

The apparatus of this embodiment 110 is especially suitable for installation in a circular storm drain, such as, for example storm drain 112, having a circular inlet 116, shown in FIG. 6. The apparatus 110 comprises a debris trap 120 and a frame 124. The frame 124 generally comprises two substantially identical L-shaped frame portions 127.

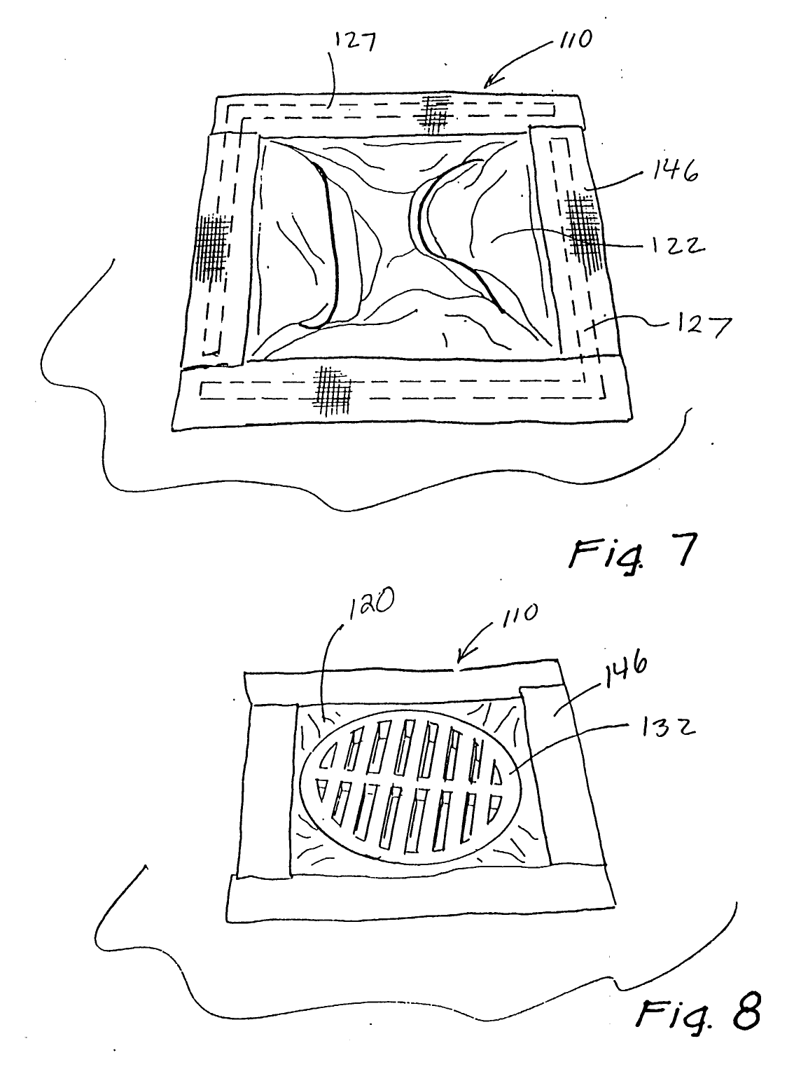

The debris trap 120 comprises panel portions 122, having elements 150 made of heavy gauge material to provide additional weight and substantially prevent bypass in low water flow conditions, and pockets 146 in each panel portion 122 for receiving the L-shaped frame portions 127 (shown in broken line in FIG. 7).

Like apparatus 10 shown in FIGS. 1-4, apparatus 110 is structured to be securely suspended in place within the drain as shown in FIG. 7, while holding a substantial volume and weight of debris, without the circular grate 132 reinstalled across the inlet 116 such as shown in FIG. 8. Handles 152 and indicator member 154 may also be provided.

Any and all features described herein and combinations of such features are included within the scope of the present invention provided that the features of any such combination are not mutually inconsistent.

While this invention has been described with respect to various specific examples and embodiments, it is to be understood that the invention is not limited thereto and that it can be variously practiced within the scope of the following claims.

What is claimed is:

1. An apparatus for removing debris from water passing through a storm drain having an inlet, the apparatus comprising:
a debris trap sized to fit within the storm drain inlet and structured to separate debris from a water flow passing therethrough; and
a frame assembly connectable to the debris trap and structured to bear on a surface of the storm drain so as to be effective to secure the debris trap in place therein.

2. The apparatus of claim 1 wherein the frame assembly is effective to support the debris trap within the storm drain independent of any storm drain grate or other form of support.

3. The apparatus of claim 1 wherein the frame assembly comprises a first frame portion having an adjustable length.

4. The apparatus of claim 3 wherein the frame assembly further comprises a second frame portion having a fixed length.

5. The apparatus of claim 4 wherein the fixed length of the second frame portion is no longer than a width of the storm drain inlet.

6. The apparatus of claim 4 wherein the second frame portion comprises a frame member structured to bear against a ledge within the storm drain.

7. The apparatus of claim 1 wherein the frame assembly comprises a first frame portion having an adjustable length and a second frame portion having a fixed length.

8. The apparatus of claim 1 wherein the frame assembly comprises a first frame portion having an adjustable length substantially corresponding to a length of the storm drain inlet, and a second frame portion having a fixed length substantially corresponding to a width of the storm drain inlet.

9. The apparatus of claim 8 wherein the debris trap includes a pocket structured for receiving the second frame portion.

10. The apparatus of claim 1 wherein the debris trap comprises a flexible mesh material.

11. The apparatus of claim 1 wherein the debris trap includes a peripheral portion structured to be effective in substantially preventing bypass of the debris trap during low flow conditions.

12. The apparatus of claim 1 wherein the debris trap includes a peripheral portion that is sized and shaped to substantially overlap a peripheral edge of the inlet of the storm drain.

13. The apparatus if claim 1 wherein the debris trap comprises a flexible material having a flow rate capacity of about 145 gallons per minute per square foot.

14. An apparatus for removing debris from water passing through a storm drain having an inlet, the apparatus comprising:
a debris trap sized to fit within the storm drain inlet and structured to separate debris from a water flow passing therethrough and including a peripheral portion that is sized and shaped to substantially overlap an edge of the inlet opening of the storm drain; and
a frame assembly connectable to the debris trap and structured to bear on a surface of the storm drain so as to be effective in securing the debris trap in place therein.

15. The apparatus of claim 14 wherein the frame assembly is effective to support the debris trap within the storm drain independent of any storm drain grate or other form of support.

16. The apparatus of claim 14 wherein the frame assembly comprises a first frame portion having an adjustable length.

17. The apparatus of claim 16 wherein the frame assembly further comprises a second frame portion having a fixed length.

18. The apparatus of claim 17 wherein the fixed length of the second frame portion is no longer than a width of the storm drain inlet.

19. The apparatus of claim 17 wherein the second frame portion comprises a frame member structured to bear against a ledge within the storm drain.

20. The apparatus of claim 14 wherein the frame assembly comprises a first frame portion having an adjustable length substantially corresponding to a length of the storm drain inlet, and a second frame portion having a fixed length substantially corresponding to a width of the storm drain inlet.

21. The apparatus of claim 16 wherein the debris trap includes a pocket structured for receiving the second frame portion.

22. The apparatus of claim 1 wherein the debris trap comprises a flexible mesh material having a flow rate capacity of about 145 gallons per minute per square foot.
